(19) United States
(12) Patent Application Publication
(10) Pub. No.: US 2026/0022935 A1
(43) Pub. Date: Jan. 22, 2026

(54) Method for Acquiring Target Thickness of Hydrogen Embrittlement-Resistant Layer of Neutron Source Target, Terminal, and Storage Medium

(71) Applicant: Huapeng Neutron Technology (Hangzhou) Co., Ltd., Hangzhou (CN)

(72) Inventors: Yupeng XIE, Hangzhou (CN); Yaocheng HU, Hangzhou (CN); Fanxi ZHANG, Hangzhou (CN); Yixin SI, Hangzhou (CN)

(21) Appl. No.: 19/270,496

(22) Filed: Jul. 16, 2025

(30) Foreign Application Priority Data
Jul. 16, 2024 (CN) 2024109484969

(51) Int. Cl. G01B 15/02; G01N 23/2255

(52) U.S. Cl. CPC G01B 15/02; G01N 23/2255

(57) ABSTRACT

The present disclosure provides a method for acquiring a target thickness of a hydrogen embrittlement-resistant layer of a neutron source target, a terminal, and a storage medium; the method includes: using a physical field fitting method, performing hydrogen diffusion performance fitting based on the deposition distribution and thermal performance fitting based on the energy distribution for the target, respectively, to correspondingly obtain hydrogen atom concentration distribution characteristic and temperature distribution characteristic corresponding to the current thickness; determining whether the hydrogen atom concentration distribution characteristic satisfies a preset condition of a hydrogen atom concentration field, and determining whether the temperature distribution characteristic satisfies a preset condition of a temperature field. if both two conditions are satisfied, then taking the current thickness as the target thickness of the hydrogen embrittlement-resistant layer.

### FIELD OF TECHNOLOGY

The present disclosure relates to the technical field of hydrogen testing, and more particularly relates to a method for acquiring a target thickness of a hydrogen embrittlement-resistant layer of a neutron source target, a terminal, and a computer-readable storage medium.

### BACKGROUND

In order to reduce the accumulation of hydrogen atoms in a target substrate and to suppress the occurrence of hydrogen embrittlement, a hydrogen embrittlement-resistant layer is typically inserted between a functional layer and the target substrate of a neutron source target. A thickness design of the hydrogen embrittlement-resistant layer directly affects the hydrogen embrittlement resistance performance of the target, and thus influences the degradation rate and service life of the target.

In the existing process for selecting a thickness of the hydrogen embrittlement-resistant layer, the material of the hydrogen embrittlement-resistant layer is typically determined first based on a material of the functional layer and a reaction threshold energy in the target; after selecting a material of the hydrogen embrittlement-resistant layer, the thickness is usually determined only by performing a hydrogen diffusion performance analysis and evaluation on the hydrogen embrittlement-resistant layer, and using a result of the hydrogen diffusion performance analysis and evaluation; however, when a low-melting-point material is selected as the functional layer of the target-for example, lithium, which has a relatively low melting point (180° C.); determining the thickness of the hydrogen embrittlement-resistant layer based solely on the hydrogen diffusion performance analysis and evaluation often results in an excessively large thickness of the hydrogen embrittlement-resistant layer. This reduces the heat dissipation performance of the hydrogen embrittlement-resistant layer, thereby increasing its surface temperature, which may lead to melting of the material in the functional layer of the target and ultimately compromise operational safety.

### SUMMARY

The present disclosure provides a method for acquiring a target thickness of a hydrogen embrittlement-resistant layer of a neutron source target, a terminal, and a computer-readable storage medium, which are intended to solve problems in the conventional design of the thickness of the hydrogen embrittlement-resistant layer-such as the failure to fully consider a deposition distribution characteristic and an energy distribution of protons within the hydrogen embrittlement-resistant layer-leading to an unreasonable thickness design of the hydrogen embrittlement-resistant layer.

A first aspect of the present disclosure provides a method for acquiring a target thickness of a hydrogen embrittlement-resistant layer of a neutron source target, wherein the target comprises a functional layer, a hydrogen embrittlement-resistant layer, and a target substrate; the method for acquiring a target thickness of a hydrogen embrittlement-resistant layer comprises: determining a current thickness of the hydrogen embrittlement-resistant layer, wherein the current thickness is greater than or equal to a reference thickness of the hydrogen embrittlement-resistant layer; using a physical field fitting method, performing hydrogen diffusion performance fitting based on the deposition distribution and thermal performance fitting based on the energy distribution for the target, respectively, to correspondingly obtain hydrogen atom concentration distribution characteristic and temperature distribution characteristic corresponding to the current thickness; determining whether the hydrogen atom concentration distribution characteristic satisfies a preset condition of a hydrogen atom concentration field, and determining whether the temperature distribution characteristic satisfies a preset condition of a temperature field. if both two conditions are satisfied, then taking the current thickness as the target thickness of the hydrogen embrittlement-resistant layer; wherein the reference thickness is determined based on the material and thickness of the functional layer, in combination with the incident proton beam energy of the target and the current material of the hydrogen embrittlement-resistant layer, to determine a reference thickness of the hydrogen embrittlement-resistant layer corresponding to the current material.

In one embodiment of the present disclosure, the method further s: if either of the two conditions is not satisfied, updating the current thickness based on a preset adjustment threshold, and re-performing the method for acquiring the target thickness of the hydrogen embrittlement-resistant layer based on the updated thickness, until the target thickness is obtained.

In one embodiment of the present disclosure, performing hydrogen diffusion performance based on the deposition distribution of the target using the physical field fitting method comprises: converting a proton flux into a corresponding hydrogen atom molar flow rate; based on the hydrogen atom molar flow rate, respectively obtaining the hydrogen atom concentration distribution along an incident direction and along a reference plane of the target using the physical field fitting method, and extracting a maximum hydrogen atom concentration from the hydrogen atom distribution of the target.

In one embodiment of the present disclosure, obtaining the temperature distribution along the incident direction using the physical field fitting method comprises: calculating the hydrogen atom concentration distribution along the incident direction of the proton beam in the target using a Monte Carlo method; and/or, obtaining the temperature distribution along the reference plane using the physical field fitting method comprises: calculating a hydrogen atom concentration distribution along the reference plane of the proton beam using a finite element simulation method, to obtain a three-dimensional hydrogen atom concentration distribution of the proton beam.

In one embodiment of the present disclosure, the three-dimensional hydrogen atom concentration distribution of the proton beam is:

$${f}_{sc} ( x , y , z ) = \frac{1}{2 {πσ}^{2}} exp ( - \frac{{x}^{2} + {y}^{2}}{2 {σ}^{2}} ) * {f}_{sc} ( z )$$

wherein f_{sc}(x, y, z) is the hydrogen atom concentration distribution of the proton beam in the three-dimensional space, x, y are coordinates of the proton beam along the reference plane; z is a coordinate of the proton beam along the incident direction; and σ is a standard deviation of a planar Gaussian distribution.

In one embodiment of the present disclosure, performing the thermal performance fitting based on the energy distribution using the physical field fitting method comprises: converting a power of the proton beam into a corresponding heat source power of the target; according to the heat source power, respectively obtaining a temperature distribution of the target along the incident direction and a temperature distribution of the target along the reference plane using the physical field fitting method; and extracting a maximum temperature from a temperature distribution corresponding to the target.

In one embodiment of the present disclosure, obtaining the temperature distribution along the incident direction using the physical field fitting method comprises: calculating a temperature distribution along the incident direction of a proton beam in the target using the Monte Carlo method; and/or, obtaining the temperature distribution along the reference plane using the physical field fitting method comprises: calculating a temperature distribution of the proton beam along the reference plane using a finite element simulation method, to obtain a three-dimensional temperature distribution of the proton beam.

In one embodiment of the present disclosure, the three-dimensional temperature distribution of the proton beam is:

$${f}_{nl} ( x , y , z ) = \frac{1}{2 {πσ}^{2}} exp ( - \frac{{x}^{2} + {y}^{2}}{2 {σ}^{2}} ) * {f}_{nl} ( z )$$

wherein fₙₗ(x, y, z) is the temperature distribution of the proton beam in the three-dimensional space; fₙₗ(z) is the temperature distribution of the proton beam along the incident direction; x, y are coordinates of the proton beam along the reference plane; z is a coordinate of the proton beam along the incident direction; and σ is a standard deviation of a planar Gaussian distribution.

In one embodiment of the present disclosure, the method for acquiring the target thickness of the hydrogen embrittlement-resistant layer of the neutron source target further comprises: performing a neutron yield performance evaluation for a target comprising the hydrogen embrittlement-resistant layer with the target thickness, to obtain a target thickness that satisfies a preset condition of neutron yield performance evaluation.

A second aspect of the present disclosure further provides a method for designing a hydrogen embrittlement-resistant layer of a neutron source target, wherein the target comprises a functional layer, a hydrogen embrittlement-resistant layer, and a target substrate; the method comprises: determining a current material of the hydrogen embrittlement-resistant layer; wherein the current material is a material with a hydrogen diffusion coefficient greater than that corresponding to the target substrate; determining a reference thickness corresponding to the current material according to a material and thickness of the functional layer, an energy of an incident proton beam of the target, and the current material of the hydrogen embrittlement-resistant layer; acquiring a target thickness of the hydrogen embrittlement-resistant layer based on the reference thickness using any of the methods above; based on the target thickness, detecting whether a neutron yield distribution of the target corresponding to the target thickness satisfies a preset neutron yield condition; if satisfied, determining the target thickness as the target thickness corresponding to the current material; and combining the current material and the corresponding target thickness to obtain a design scheme of the hydrogen embrittlement-resistant layer.

In an embodiment of the present disclosure, detecting whether the neutron yield distribution corresponding to the target thickness satisfies the preset neutron yield condition comprises: constructing a simulation model for simulating a proton beam vertically bombarding the target based on the target corresponding to the target thickness, wherein the simulation model is a spherical coordinate system centered on the target; extracting a neutron yield within a preset radiation range along a proton emission direction of the target in the simulation model; detecting whether the neutron yield satisfies a preset yield threshold; if so, determining that the neutron yield of the target corresponding to the target thickness meets the preset neutron yield requirement.

The present disclosure provides further provides a terminal, the terminal comprises a processor and a memory; the memory is configured to store a computer program, and the processor is configured to execute the computer program stored in the memory, so that the terminal performs the method for acquiring the target thickness of the hydrogen embrittlement-resistant layer of the neutron source target as described, or the method for designing the hydrogen embrittlement-resistant layer as described.

In addition, the present disclosure further provides a computer-readable storage medium storing a computer program; the computer program, when executed by a processor, implements the method for acquiring the target thickness of the hydrogen embrittlement-resistant layer of the neutron source target as described, or the method for designing the hydrogen embrittlement-resistant layer as described.

As described above, the method for acquiring a target thickness of a hydrogen embrittlement-resistant layer of a neutron source target, the terminal, and the computer-readable storage medium provided by the present disclosure enable a comprehensive performance evaluation of hydrogen diffusion performance and thermal performance to be respectively performed on a target comprising a hydrogen embrittlement-resistant layer. Based on the evaluation results, a target thickness that satisfies both a preset condition of a hydrogen atom concentration field and a preset condition of a temperature field is acquired. As a result, the target thickness of the hydrogen embrittlement-resistant layer that is compatible with the physical field performance of other structural layers (such as a functional layer) of the target can be quickly and conveniently obtained. This not only enhances the hydrogen embrittlement resistance of the target, but also effectively improves the overall performance of the target.

### BRIEF DESCRIPTION OF THE DRAWINGS

FIG. 1 shows a schematic structural diagram of a neutron source target according to the present disclosure;

FIG. 2 shows a schematic flowchart of a method for acquiring a target thickness of a hydrogen embrittlement-resistant layer of the neutron source target according to one embodiment of the present disclosure;

FIG. 3 shows a schematic flowchart of Step S200 according to one embodiment of the present disclosure;

FIG. 4 shows a schematic flowchart of Step S200 according to another embodiment of the present disclosure;

FIG. 5 shows a schematic flowchart of performing a hydrogen diffusion performance fitting based on a deposition distribution for the target corresponding to the current thickness, to obtain a hydrogen atom concentration distribution characteristic according to one embodiment of the present disclosure;

FIG. 6 shows a schematic flowchart of performing a thermal performance fitting based on an energy distribution for the target corresponding to the current thickness, to obtain a temperature distribution characteristic according to one embodiment of the present disclosure;

FIG. 7 shows a schematic flowchart of the method for acquiring the target thickness of the hydrogen embrittlement-resistant layer of the neutron source target according to another embodiment of the present disclosure;

FIG. 8 shows a schematic diagram of a coordinate system of a simulation model in which a proton beam vertically bombards the target according to the present disclosure;

FIG. 9 shows a schematic flowchart of the method for acquiring the target thickness of the hydrogen embrittlement-resistant layer of the neutron source target according to yet another embodiment of the present disclosure;

FIG. 10 shows a schematic flowchart of a method for designing a hydrogen embrittlement-resistant layer of the neutron source target according to one embodiment of the present disclosure;

FIG. 11 shows a schematic flowchart of the method for designing the hydrogen embrittlement-resistant layer of the neutron source target according to another embodiment of the present disclosure;

FIG. 12 shows a schematic structural diagram of a terminal according to one embodiment of the present disclosure.

### DETAILED DESCRIPTION

The embodiments of the present disclosure will be described below. Those skilled can easily understand advantages and effects of the present disclosure according to contents disclosed by the specification. The present disclosure can also be implemented or applied through other different exemplary embodiments. Various modifications or changes can also be made to all details in the specification based on different points of view and disclosures without departing from the spirit of the present disclosure. It should be noted that the following embodiments and the features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components' layout may also be more complicated.

In the conventional process for selecting the thickness of a hydrogen embrittlement-resistant layer, a deposition distribution characteristic of hydrogen atom concentration and an energy distribution within a target comprising the hydrogen embrittlement-resistant layer are not fully considered, resulting in an unreasonable design of the hydrogen embrittlement-resistant layer. A method for acquiring a target thickness of a hydrogen embrittlement-resistant layer of a neutron source target, a terminal, and a computer-readable storage medium provided by the present disclosure enable a target comprising the hydrogen embrittlement-resistant layer to undergo a hydrogen diffusion performance evaluation based on a deposition distribution and a thermal diffusion performance evaluation based on an energy distribution. Based on the evaluation results of both the hydrogen diffusion performance and the thermal diffusion performance, it is determined whether a current thickness of the hydrogen embrittlement-resistant layer qualifies as a target thickness, so as to ensure that the hydrogen embrittlement-resistant layer with the target thickness can be compatible with the physical field performance of other structural layers (such as a functional layer) of the target.

The target thickness refers to a thickness of the hydrogen embrittlement-resistant layer that satisfies at least both a preset condition of a hydrogen atom concentration field and a preset condition of a temperature filed.

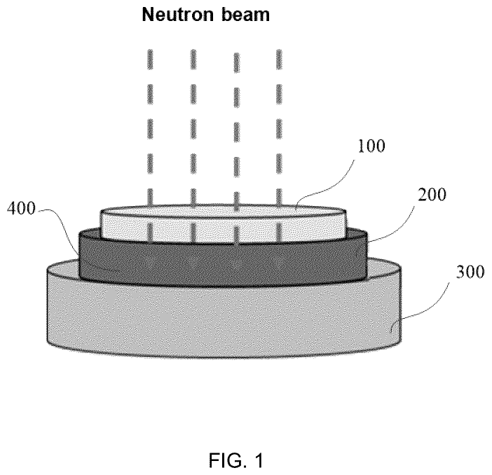

Please refer to FIG. 1, which shows a schematic structural diagram of a neutron source target according to one embodiment of the present disclosure. As shown in FIG. 1, the target comprises a functional layer 100, a hydrogen embrittlement-resistant layer 200, and a target substrate 300; these layers are stacked and arranged to form the target; the functional layer 100 is disposed on a side facing an incident direction of a proton beam and is configured to generate neutrons under the action of the proton beam; the target substrate 300 is used to support the functional layer 100 and the hydrogen embrittlement-resistant layer 200; the hydrogen embrittlement-resistant layer 200 is disposed between the functional layer 100 and the target substrate 300.

The proton beam is incident into the target along an incident direction. A portion of the energy carried by the protons undergoes nuclear reactions in the functional layer 100 to produce neutrons, while the remaining energy of the protons is reduced as they pass through the hydrogen embrittlement-resistant layer 200, ultimately coming to rest within the hydrogen embrittlement-resistant layer 200. Due to the Bragg peak effect, most of the decelerated protons are finally concentrated in a hydrogen accumulation layer 400 located at the tail end of the proton range.

In one specific embodiment, the hydrogen embrittlement-resistant layer is welded between the functional layer and the target substrate.

It should be noted that in the present disclosure, the hydrogen embrittlement-resistant layer refers to a material layer whose hydrogen diffusion coefficient is greater than that of the material corresponding to the target substrate. This layer is used to accommodate hydrogen atoms generated during the neutron source reaction process, thereby improving the hydrogen embrittlement resistance of the target. Exemplarily, the material of the hydrogen embrittlement-resistant layer comprises, but is not limited to, tantalum (Ta), vanadium (V), and niobium (Nb).

In order to improve the accuracy of acquiring the target thickness corresponding to the hydrogen embrittlement-resistant layer—so that the hydrogen embrittlement-resistant layer at the target thickness can be more compatible with the design of other structural layers of the target (such as the functional layer); the method for acquiring a target thickness of the hydrogen embrittlement-resistant layer of the neutron source target provided in the first aspect of the present disclosure is configured to acquire a target thickness of the hydrogen embrittlement-resistant layer in a target.

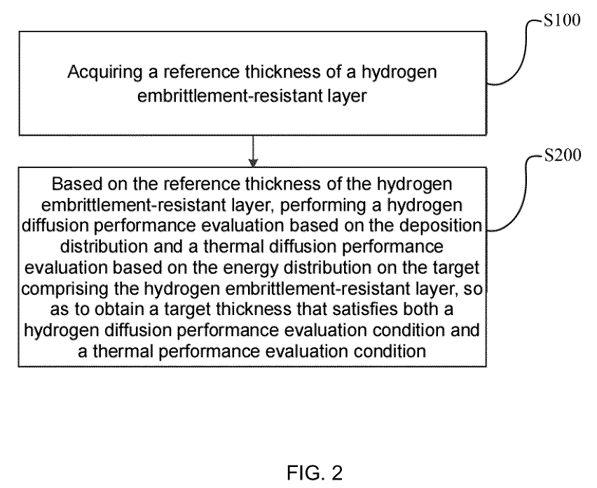

Please refer to FIG. 2, which shows a schematic flowchart of a method for acquiring a target thickness of a hydrogen embrittlement-resistant layer of a neutron source target according to one embodiment of the present disclosure. As shown in FIG. 2, the method comprises the following steps:
S100, acquiring a reference thickness of the hydrogen embrittlement-resistant layer;
after determining a material of the hydrogen embrittlement-resistant layer, a reference thickness corresponding to the material of the hydrogen embrittlement-resistant layer is determined;
the reference thickness is determined based on the material and thickness of the functional layer, in combination with the incident proton beam energy of the target and a current material of the hydrogen embrittlement-resistant layer, so as to determine a reference thickness of the hydrogen embrittlement-resistant layer corresponding to the current material; that is, the reference thickness is determined according to a threshold energy for a nuclear reaction between the incident protons and the material of the functional layer (for generating neutrons), wherein the threshold energy refers to the energy of the incident protons after passing through the functional layer and entering the hydrogen embrittlement-resistant layer.

The thickness is determined based on the energy of the incident protons entering the hydrogen embrittlement-resistant layer, so as to ensure that the protons remain within the hydrogen embrittlement-resistant layer and do not penetrate into the target substrate; the incident proton energy corresponds to the threshold energy at which protons react with the material of the functional layer, allowing the protons to pass through the functional layer and enter the hydrogen embrittlement-resistant layer.

Exemplarily, when the material of the hydrogen embrittlement-resistant layer is tantalum and the energy of the incident protons is 1.88 MeV, the reference thickness of the hydrogen embrittlement-resistant layer is 20 um. That is, when the thickness of the hydrogen embrittlement-resistant layer is greater than 20 um, the protons remain within the hydrogen embrittlement-resistant layer without penetrating into the target substrate, and therefore, all candidate thicknesses are greater than 20 um.

S200, based on the reference thickness of the hydrogen embrittlement-resistant layer, performing a hydrogen diffusion performance evaluation based on the deposition distribution and a thermal diffusion performance evaluation based on the energy distribution on the target comprising the hydrogen embrittlement-resistant layer, so as to obtain a target thickness that satisfies both a hydrogen diffusion performance evaluation condition and a thermal performance evaluation condition.

The hydrogen diffusion performance refers to a physical field characteristic that characterizes the diffusion capability of hydrogen atoms; the thermal diffusion performance evaluation refers to a physical field characteristic that characterizes the diffusion capability of temperature.

In the present disclosure, the hydrogen diffusion performance evaluation based on the deposition distribution adopts a concentration distribution evaluation based on a hydrogen atom concentration distribution characteristic. The thermal diffusion performance evaluation based on the energy distribution adopts a temperature distribution evaluation based on a temperature distribution characteristic.

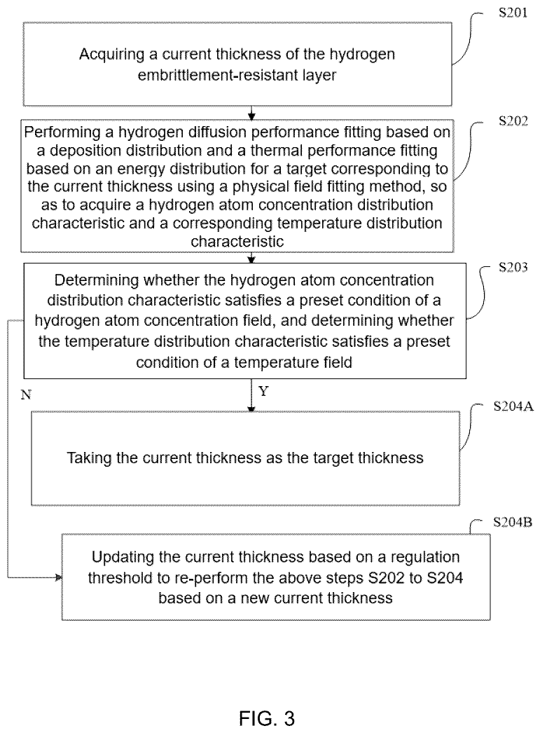

In order to achieve accurate screening of the target thickness, in some optional embodiments, Step S200, when executed, comprises the following sub-steps as shown in FIG. 3:
S201, acquiring a current thickness of the hydrogen embrittlement-resistant layer;
the current thickness is greater than or equal to the reference thickness of the hydrogen embrittlement-resistant layer.

It should be noted that, upon the first execution of this step, the current thickness is a thickness value slightly greater than or equal to the reference thickness.

S202, performing a hydrogen diffusion performance fitting based on a deposition distribution and a thermal performance fitting based on an energy distribution for a target corresponding to the current thickness using a physical field fitting method, so as to acquire a hydrogen atom concentration distribution characteristic and a corresponding temperature distribution characteristic;
the target corresponding to the current thickness refers to a target structure comprising a hydrogen embrittlement-resistant layer with the current thickness, i.e., at least comprising a functional layer, a hydrogen embrittlement-resistant layer, and a target substrate.
S203, determining whether the hydrogen atom concentration distribution characteristic satisfies a preset condition of a hydrogen atom concentration field, and determining whether the temperature distribution characteristic satisfies a preset condition of a temperature field;
S204A, if both conditions are satisfied, then taking the current thickness as the target thickness;
S204B, if at least one of the two conditions is not satisfied, then updating the current thickness based on a preset regulation threshold, to re-perform the above steps S202 to S204 (S204A or S204B) based on a new current thickness.

The regulation threshold is matched with a preset thickness adjustment range of the hydrogen embrittlement-resistant layer; specifically, the larger the thickness adjustment range, the greater the regulation threshold, and the smaller the thickness adjustment range, the smaller the regulation threshold. It should be noted that the adjustment threshold is a preset thickness adjustment amount. The setting of this adjustment amount needs to satisfy two evaluation criteria—hydrogen diffusion performance and thermal performance. For hydrogen diffusion performance, the adjustment threshold must meet the hydrogen embrittlement limit of the hydrogen-resistant material, e.g., 9.2×10³ mol/m³ for Ta and 3.5×10⁴ mol/m³ for V. For thermal performance, the adjustment threshold refers to the temperature requirement of the target, such as the melting point requirement of the functional layer. The thickness adjustment range refers to the preset thickness range of the hydrogen embrittlement-resistant layer defined during the initial design; for example, the thickness adjustment range is 20-30 um.

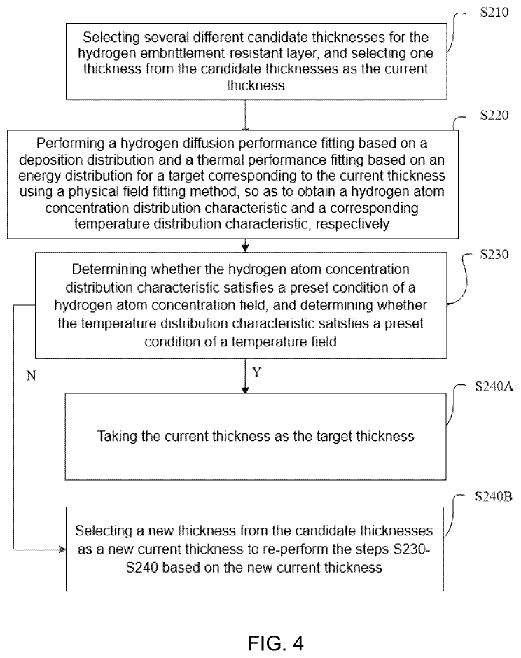

To improve the efficiency of acquiring the target thickness, in an optional embodiment, Step S200, when executed, comprises the following sub-steps as shown in FIG. 4:
S210, selecting several different candidate thicknesses for the hydrogen embrittlement-resistant layer; selecting one thickness from the candidate thicknesses as the current thickness;
all candidate thicknesses are greater than or equal to the reference thickness of the hydrogen embrittlement-resistant layer.

Specifically, after acquiring the reference thickness of the hydrogen embrittlement-resistant layer, several thicknesses are randomly selected within a candidate thickness range as the candidate thicknesses of the hydrogen embrittlement-resistant layer; the candidate thickness range is defined as a value range not less than the reference thickness.

S220, performing a hydrogen diffusion performance fitting based on a deposition distribution and a thermal performance fitting based on an energy distribution for a target corresponding to the current thickness using a physical field fitting method, so as to obtain a hydrogen atom concentration distribution characteristic and a corresponding temperature distribution characteristic, respectively;
S230, determining whether the hydrogen atom concentration distribution characteristic satisfies a preset condition of a hydrogen atom concentration field, and determining whether the temperature distribution characteristic satisfies a preset condition of a temperature field;
S240A, if both two conditions are satisfied, then taking the current thickness as the target thickness;
S240B, if at least one of the two conditions is not satisfied, selecting a new thickness from the candidate thicknesses as a new current thickness to re-perform the steps S230 to S240 (S240A or S240B) based on the new current thickness.

It should be noted that, in some embodiments, the above Steps S230 to S240 may also be executed in parallel. That is, for each candidate thickness, the above Steps S230 to S240 are performed simultaneously, so as to quickly determine whether each of the candidate thicknesses qualifies as the target thickness.

In a specific embodiment, the hydrogen atom concentration distribution characteristic is represented by a maximum hydrogen atom concentration, and the temperature distribution characteristic is represented by a maximum temperature; if the detected maximum hydrogen atom concentration exceeds a hydrogen concentration threshold, and the maximum temperature exceeds a temperature threshold, the current thickness is then set as the target thickness;
the concentration threshold is a hydrogen capacity limit of the hydrogen embrittlement-resistant layer and corresponds to the material of the hydrogen embrittlement-resistant layer.

The temperature threshold corresponds to the melting point of the material of the hydrogen embrittlement-resistant layer, and is associated with the material of the hydrogen embrittlement-resistant layer, a cooling structure of the target, and a flow rate of a cooling fluid.

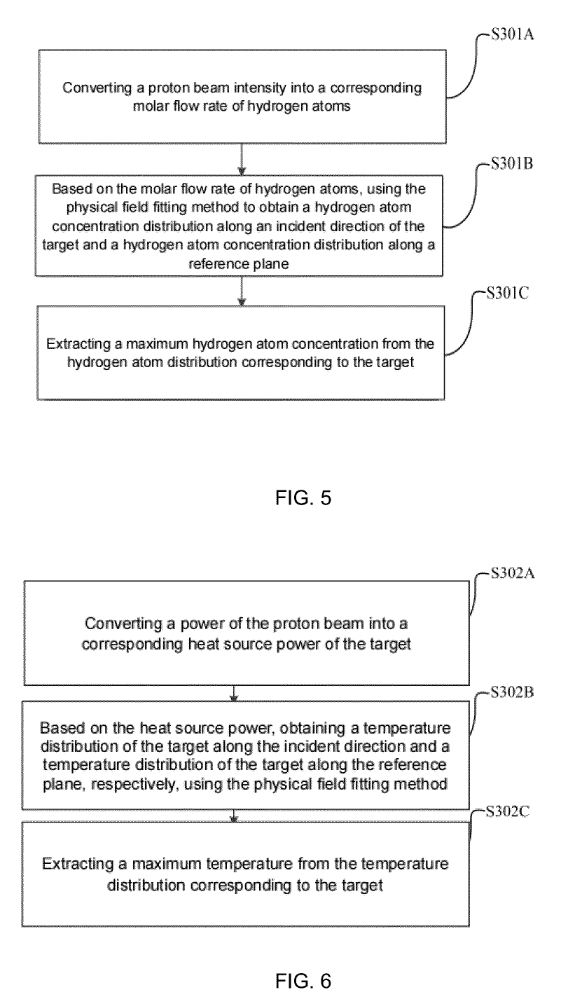

In the related art, since the hydrogen diffusion performance fitting based on existing methods is typically derived solely from simulating the hydrogen atom concentration distribution of the proton beam in the longitudinal direction, such simulation cannot accurately and comprehensively characterize the actual spatial distribution of the proton beam in three-dimensional space; as a result, the impact of proton bombardment on the three-dimensional structure of the target cannot be precisely determined, leading to low accuracy in the obtained hydrogen atom concentration distribution characteristic; similarly, temperature distribution characteristics obtained through existing methods also tend to suffer from low accuracy;
to improve the accuracy of the hydrogen atom concentration distribution characteristic obtained through fitting, in some optional embodiments, the implementation of performing a hydrogen diffusion performance fitting based on a deposition distribution for a target corresponding to the current thickness—so as to obtain the hydrogen atom concentration distribution characteristic—is illustrated in FIG. 5, and comprises:
S301A, converting a proton beam intensity into a corresponding molar flow rate of hydrogen atoms;
S301B, based on the molar flow rate of hydrogen atoms, using the physical field fitting method to obtain a hydrogen atom concentration distribution along an incident direction of the target and a hydrogen atom concentration distribution along a reference plane;
the reference plane is a plane perpendicular to the incident direction;
specifically, the hydrogen atom concentration distribution of the proton beam in the three-dimensional space comprises a one-dimensional distribution along the incident direction and a two-dimensional distribution on the reference plane; the two-dimensional distribution may be implemented by, but is not limited to, a Gaussian distribution, uniform distribution, top-hat distribution, Laplace distribution, or annular distribution.

S301C, extracting a maximum hydrogen atom concentration from the hydrogen atom distribution corresponding to the target.

In a specific embodiment, when the two-dimensional distribution adopts a Gaussian distribution, obtaining the hydrogen atom concentration distribution along an incident direction of the target and a hydrogen atom concentration distribution along the reference plane using the physical field fitting method comprises:
calculating the hydrogen atom concentration distribution of the proton beam in the hydrogen embrittlement-resistant layer and the target substrate along the incident direction using a Monte Carlo method; calculating a hydrogen atom concentration distribution along the reference plane of the proton beam using a finite element simulation method, to obtain a three-dimensional hydrogen atom concentration distribution of the proton beam, which is:

$${f}_{sc} ( x , y , z ) = \frac{1}{2 {πσ}^{2}} exp ( - \frac{{x}^{2} + {y}^{2}}{2 {σ}^{2}} ) * {f}_{sc} ( z )$$

wherein f_{sc}(x, y, z) is the hydrogen atom concentration distribution of the proton beam in the three-dimensional space, x, y are coordinates of the proton beam along the reference plane; z is a coordinate of the proton beam along the incident direction; and σ is a standard deviation of a planar Gaussian distribution. Exemplarily, σ is one-third of the spot radius of the proton beam formed on the reference plane.

More specifically, a TRIM (Transport of Ions in Matter) fitting module within the SRIM (Stopping and Range of Ions in Matter) software is used to obtain the hydrogen atom concentration distribution along the incident direction; and a “Transport of Diluted Species” module within COMSOL Multiphysics is used to perform finite element simulation of hydrogen diffusion based on preset boundary conditions; the boundary conditions comprise: an initial hydrogen atom concentration of zero within the target;
hydrogen atoms escaping after reaching the front surface and back surface of the target, i.e., setting the hydrogen atom concentration to zero on the front and back surfaces of the target, while setting the remaining surfaces as no-flux boundaries; and an isotropic diffusion coefficient of hydrogen atoms within the hydrogen embrittlement-resistant layer and the functional layer.

After obtaining the hydrogen atom concentration distribution of the proton beam in three-dimensional space, to more accurately extract the maximum hydrogen atom concentration, in a specific embodiment, the implementation of extracting the maximum hydrogen atom concentration from the hydrogen atom distribution of the target comprises:
Performing mesh discretization on a three-dimensional region to obtain P mesh nodes;
extracting the three-dimensional coordinates corresponding to each mesh node; the three-dimensional coordinates comprise a first coordinate zᵢ in the incident direction, and a coordinate pair on the reference plane; the coordinate pair consists of a second coordinate xᵢ and a third coordinate yᵢ, which are orthogonal to each other on the reference plane;
extracting the hydrogen atom concentration corresponding to each mesh node i, and selecting the maximum hydrogen atom concentration from among all mesh nodes.

This extraction process comprises:
Acquiring a first hydrogen atom concentration C_{S}(zᵢ) corresponding to a first coordinate zᵢ based on the hydrogen atom concentration distribution of the target along the incident direction; and acquiring a second hydrogen atom concentration CM (xᵢ, yᵢ) based on the hydrogen atom concentration distribution of the target on the reference plane;
combining the first hydrogen atom concentration C_{S}(zᵢ) and the second hydrogen atom concentration C_{M}(xᵢ, yᵢ) to obtain the hydrogen atom concentration C_{H}(xᵢ, yᵢ, zᵢ) corresponding to the current node.

It should be noted that, in other embodiments, the hydrogen atom concentration distribution on the reference plane may also be obtained by using other finite element software such as ANSYS in place of COMSOL Multiphysics.

To improve the accuracy of the temperature distribution characteristic obtained through fitting, in some optional embodiments, the implementation of performing a thermal performance fitting based on an energy distribution for a target corresponding to the current thickness—so as to obtain the temperature distribution characteristic—is illustrated in FIG. 6, and comprises:
S302A, converting a power of the proton beam into a corresponding heat source power of the target;
S302B, based on the heat source power, obtaining a temperature distribution of the target along the incident direction and a temperature distribution of the target along the reference plane, respectively, using the physical field fitting method;
S302B, extracting a maximum temperature from the temperature distribution corresponding to the target.

In a specific embodiment, when the two-dimensional distribution adopts a Gaussian distribution, obtaining the temperature distribution along an incident direction and the temperature distribution along a reference plane of the target using the physical field fitting method comprises:
calculating a temperature distribution of the proton beam in the hydrogen embrittlement-resistant layer and the target substrate along the incident direction using the Monte Carlo method; and calculating the temperature distribution of the proton beam along the reference plane of the proton beam using a finite element simulation method, to obtain a three-dimensional hydrogen atom concentration distribution of the proton beam, which is:

$${f}_{nl} ( x , y , z ) = \frac{1}{2 {πσ}^{2}} exp ( - \frac{{x}^{2} + {y}^{2}}{2 {σ}^{2}} ) * {f}_{nl} ( z )$$

wherein fₙₗ(x, y, z) is the temperature distribution of the proton beam in the three-dimensional space; fₙₗ(z) is the temperature distribution of the proton beam along the incident direction; x, y are coordinates of the proton beam along the reference plane; z is a coordinate of the proton beam along the incident direction; and σ is a standard deviation of a planar Gaussian distribution. σ is one-third of the spot radius of the proton beam formed on the reference plane.

More specifically, obtaining a temperature distribution along an incident direction and a temperature distribution along a reference plane of the target using a physical field fitting method comprises:

Using the TRIM fitting module in the SRIM software to obtain an energy distribution of the target along the incident direction; and using the “Heat Transfer in Solids” module in COMSOL Multiphysics to perform finite element simulation of the temperature field based on preset boundary conditions, so as to obtain the energy distribution along the reference plane.

After obtaining the temperature distribution of the proton beam in three-dimensional space, in order to more accurately extract the maximum temperature, in a specific embodiment, the process of extracting the maximum temperature from the temperature distribution of the target comprises:
Performing a second mesh discretization on the three-dimensional region to obtain Q mesh nodes;
Extracting the three-dimensional coordinates corresponding to each mesh node; The three-dimensional coordinates comprise a first coordinate zi in the incident direction, and a coordinate pair on the reference plane, where the coordinate pair comprises a second coordinate xᵢ and a third coordinate yᵢ, which are orthogonal to each other on the reference plane;
Extracting the temperature corresponding to each mesh node, and selecting the maximum temperature from among all mesh nodes.

This extraction process comprises:

Acquiring a first temperature W_{S}(zᵢ) corresponding to a first coordinate zᵢ based on the temperature distribution of the target along the incident direction; and acquiring a second temperature WM (xᵢ, yᵢ) corresponding to second and third coordinates (xᵢ, yᵢ) based on the temperature distribution of the target on the reference plane;

combining the first temperature W_{S}(zᵢ) and the second temperature W_{M}(xᵢ, yᵢ) to obtain a temperature W_{H}(xᵢ, yᵢ, zᵢ) corresponding to the current mesh node.

It should be noted that, in other embodiments, the temperature distribution of the target on the reference plane may also be obtained by using other finite element software methods such as ANSYS, instead of COMSOL Multiphysics.

The method for acquiring a target thickness of a hydrogen embrittlement-resistant layer in a neutron source target provided in this embodiment performs a hydrogen diffusion performance evaluation based on a deposition distribution, as well as a thermal performance evaluation based on an energy distribution, on a target that comprises the hydrogen embrittlement-resistant layer. In doing so, a target thickness that simultaneously satisfies the conditions for hydrogen diffusion performance and thermal performance is obtained. This enables the rapid and convenient determination of a target thickness of the hydrogen embrittlement-resistant layer that is well-matched to the thickness and material of the action layer, thereby enhancing the hydrogen embrittlement resistance of the target while also effectively improving its thermal performance.

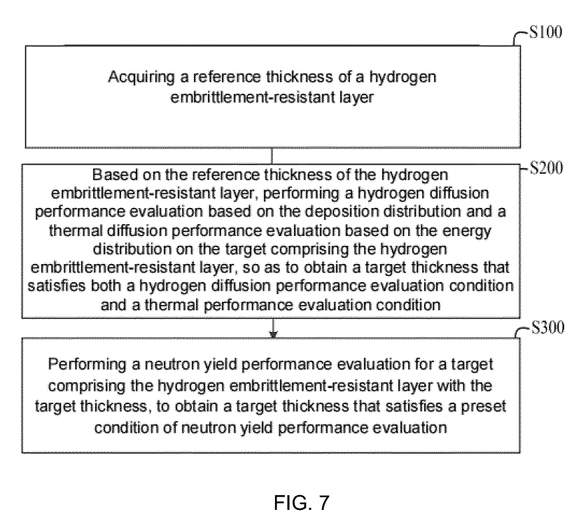

In some embodiments, after introducing the hydrogen embrittlement-resistant layer into the target structure, the layer may interact with the neutrons generated within the target, thereby affecting the neutron yield performance. To minimize the impact of the hydrogen embrittlement-resistant layer on the neutron yield of the target and to further improve the accuracy of the comprehensive performance evaluation of the hydrogen embrittlement-resistant layer, in some optional embodiments, the method for acquiring the target thickness of the hydrogen embrittlement-resistant layer in the neutron source target, after executing step S200, further comprises, as shown in FIG. 7:

S300, performing a neutron yield performance evaluation for a target comprising the hydrogen embrittlement-resistant layer with the target thickness, to obtain a target thickness that satisfies a preset condition of neutron yield performance evaluation.

Specifically, the execution of step S300 comprises:
Using the target thickness obtained in step S200 as an initial target thickness;
for a single initial target thickness, constructing a simulation model based on the corresponding target (which comprises the hydrogen embrittlement-resistant layer having the initial target thickness) to simulate the vertical bombardment of the target by a proton beam. wherein the simulation model is a spherical coordinate system centered on the target;
extracting a neutron yield within a preset radiation range along a proton emission direction of the target in the simulation model;
detecting whether the neutron yield satisfies a preset yield threshold; if so, determining that the neutron yield of the target corresponding to the initial target thickness meets the preset neutron yield requirement, and setting the initial target thickness as the final target thickness; if not, determining that the neutron yield of the target corresponding to the target thickness fail to meet the preset neutron yield requirement. The preset neutron yield requirement may comprise one or more performance thresholds such as the neutron energy spectrum, neutron angular distribution, or other neutron yield-related characteristics.

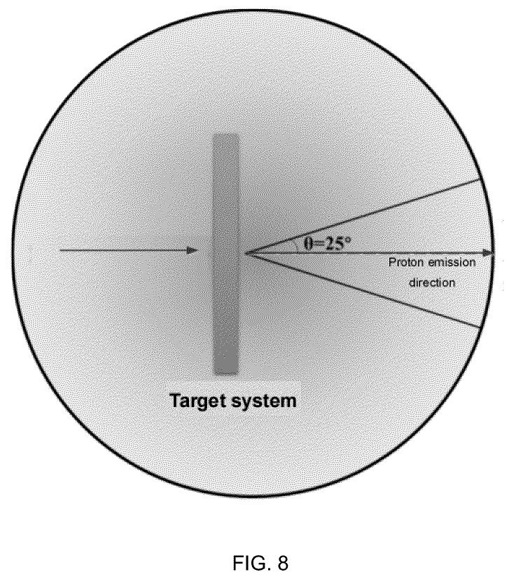

More specifically, PHITS software is used to construct the simulation model of the proton beam vertically bombarding the target. As shown in FIG. 8, this simulation model is a spherical coordinate system in which the center of the target serves as the center of the sphere, and the proton beam direction is defined as the positive z-axis. The neutron yield within 50° along the proton emission direction of the target is extracted.

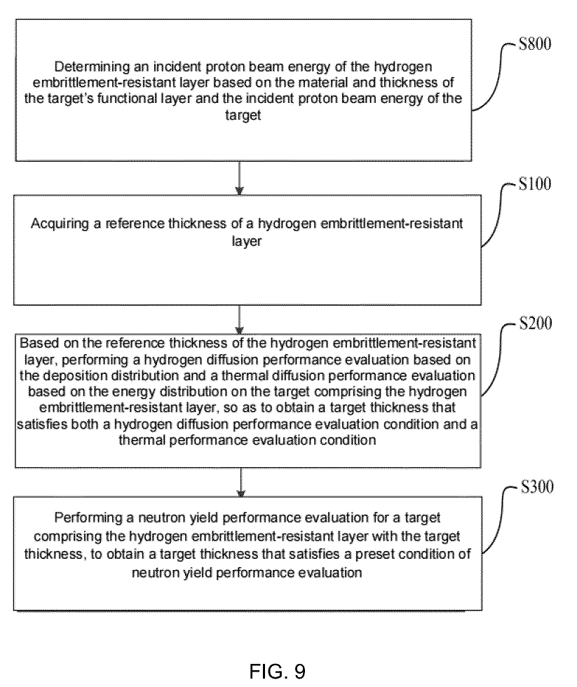

In some optional embodiments, before performing Step S100, the method for acquiring the target thickness of the hydrogen embrittlement-resistant layer of a neutron source target, as shown in FIG. 9, further comprises:
S800, determining an incident proton beam energy of the hydrogen embrittlement-resistant layer based on the material and thickness of the target's functional layer and the incident proton beam energy of the target; after determining the material of the hydrogen embrittlement-resistant layer, acquiring a reference thickness of the hydrogen embrittlement-resistant layer by combining the material type of the hydrogen embrittlement-resistant layer with the incident proton beam energy thereof.

Specifically, after determining the material of the functional layer, a reaction energy threshold corresponding to this functional layer is determined; based on the reaction energy threshold and the magnitude of the incident proton beam energy of the target, the thickness of the functional layer is determined;
after determining the material and thickness of the functional layer, the incident proton beam energy of the hydrogen embrittlement-resistant layer is determined based on the incident proton beam energy of the target;
according to the material type of the hydrogen embrittlement-resistant layer and the incident proton beam energy of the hydrogen embrittlement-resistant layer, a Monte Carlo method is employed to acquire the reference thickness of the hydrogen embrittlement-resistant layer.

The reaction energy threshold is the minimum energy threshold required by protons to react with the material of the functional layer to generate neutrons.

More specifically, the implementation of determining the thickness of the functional layer based on the reaction energy threshold and the magnitude of the incident proton beam energy comprises:

Acquiring a first proton range of the proton beam in the functional layer along the incident direction using the SRIM (Stopping and Range of Ions in Matter) method based on the beam parameters of the current proton beam; and acquiring a second proton range corresponding to the reaction energy threshold according to the reaction energy threshold; subtracting the second proton range from the first proton range to obtain a range difference, which is taken as the effective thickness of the functional layer.

In a second aspect, the present disclosure further provides a method for designing a hydrogen embrittlement-resistant layer of a neutron source target, which is used to acquire a design scheme of a hydrogen embrittlement-resistant layer adapted to a design scheme of a functional layer within the target; the design scheme of the hydrogen embrittlement-resistant layer comprises the material and thickness of the structural layer.

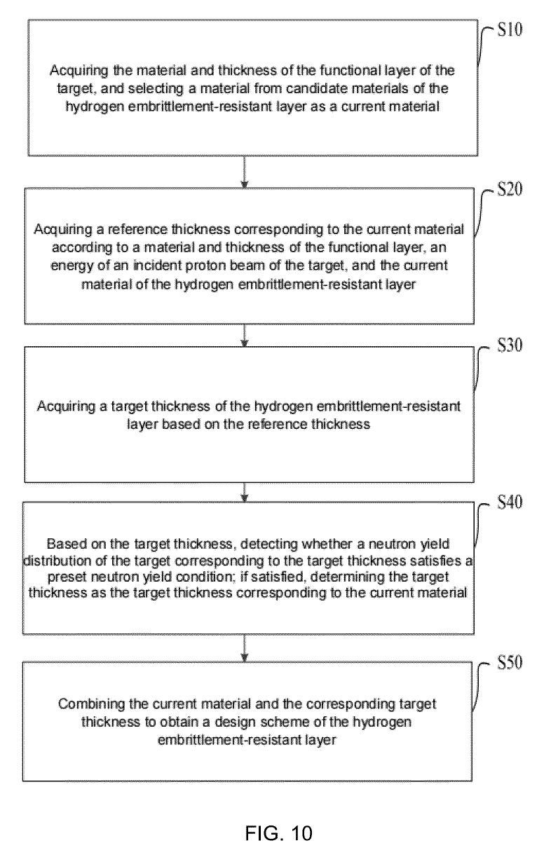

Please refer to FIG. 10, which shows a schematic flow diagram of the method for designing the hydrogen embrittlement-resistant layer of the neutron source target in one embodiment. As shown in FIG. 10, the method comprises:
S10, acquiring the material and thickness of the functional layer of the target, and selecting a material from candidate materials of the hydrogen embrittlement-resistant layer as a current material;
the candidate materials of the hydrogen embrittlement-resistant layer are all materials whose hydrogen diffusion coefficient is greater than that of the target substrate, and are configured to accommodate hydrogen atoms generated during the neutron source reaction process, thereby improving the hydrogen embrittlement resistance of the target.

Exemplarily, the material of the hydrogen embrittlement-resistant layer may comprise, but is not limited to, tantalum (Ta), vanadium (V), and niobium (Nb).

S20, acquiring a reference thickness corresponding to the current material according to a material and thickness of the functional layer, an energy of an incident proton beam of the target, and the current material of the hydrogen embrittlement-resistant layer;
specifically, determining an incident proton beam energy of the hydrogen embrittlement-resistant layer based on the material and thickness of the functional layer and the magnitude of the incident proton beam energy of the target;
and acquiring a reference thickness corresponding to the current material of the hydrogen embrittlement-resistant layer based on the current material of the hydrogen embrittlement-resistant layer and the incident proton beam energy thereof.

S30, acquiring a target thickness of the hydrogen embrittlement-resistant layer based on the reference thickness;
specifically, after determining the reference thickness of the hydrogen embrittlement-resistant layer, acquiring the target thickness of the hydrogen embrittlement-resistant layer using any of the methods for acquiring a target thickness of the hydrogen embrittlement-resistant layer of the neutron source target described in the above embodiments.

S40, based on the target thickness, detecting whether a neutron yield distribution of the target corresponding to the target thickness satisfies a preset neutron yield condition; if satisfied, determining the target thickness as the target thickness corresponding to the current material;
Specifically, the implementation of this step is the same as that in the above embodiment and will not be described again here.

S50, combining the current material and the corresponding target thickness to obtain a design scheme of the hydrogen embrittlement-resistant layer.

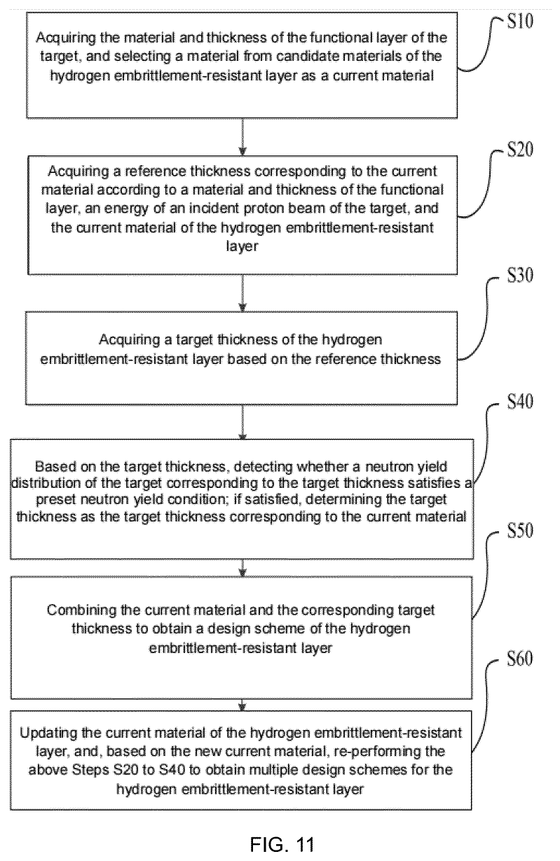

It should be noted that, in other embodiments, after executing Step S50, the method for designing the hydrogen embrittlement-resistant layer of the neutron source target, as shown in FIG. 11, further comprises:
S60, updating the current material of the hydrogen embrittlement-resistant layer, and, based on the new current material, re-performing the above Steps S20 to S40 to obtain multiple design schemes for the hydrogen embrittlement-resistant layer.

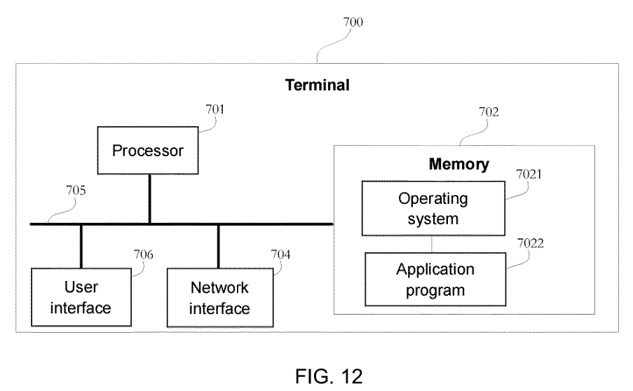

The present disclosure further provides a terminal. Please refer to FIG. 12, which illustrates a schematic structural diagram of the terminal according to the present disclosure. As shown in FIG. 12, the terminal 700 comprises a memory 702 and a processor 701 that are interconnected; the memory 702 is configured to store a computer program, and the processor 701 is configured to execute the computer program stored in the memory so as to enable the terminal to implement steps of the method for acquiring the target thickness of the hydrogen embrittlement-resistant layer of the neutron source target or the method for designing the hydrogen embrittlement-resistant layer of the neutron source target when executed.

Optionally, the number of memories may be one or more, and the number of processors may also be one or more.

Optionally, in the terminal, the processor loads one or more instructions corresponding to an disclosure process onto the memory according to the steps of the above-described method for acquiring the target thickness of the hydrogen embrittlement-resistant layer of the neutron source target, and the processor runs the disclosure stored in the memory to implement each function of the method for acquiring the target thickness of the hydrogen embrittlement-resistant layer of the neutron source target as described above.

It should be noted that the memory comprises, but is not limited to, Random Access Memory (RAM), and may also comprise non-volatile memory, such as at least one disk storage device. Similarly, the processor may be a general-purpose processor, comprising, for example, a Central Processing Unit (CPU), a Network Processor (NP), etc.;

It may also be a Digital Signal Processor (DSP), an Application Specific Integrated Circuit (ASIC), a Field-Programmable Gate Array (FPGA), or other programmable logic devices, discrete gate or transistor logic devices, or discrete hardware components.

The present disclosure also provides a computer-readable storage medium storing a computer program which, when invoked by the processor, implements the method for acquiring the target thickness of the hydrogen embrittlement-resistant layer of the neutron source target or the method for designing the hydrogen embrittlement-resistant layer of the neutron source target.

The computer-readable storage medium can be a tangible device capable of retaining and storing instructions for use by an instruction execution device. The computer-readable storage media comprise (but are not limited to): electrical storage devices, magnetic storage devices, optical storage devices, electromagnetic storage devices,
semiconductor storage devices, or any suitable combination thereof. More specific examples of the computer-readable storage media (a non-exhaustive list) comprise: portable computer disks, hard disks, Random Access Memory (RAM), Read-Only Memory (ROM), Erasable Programmable Read-Only Memory (EPROM) or flash memory, Static Random Access Memory (SRAM), portable compact disc read-only memory (CD-ROM), Digital Versatile Discs (DVD), memory sticks, floppy disks, mechanically encoded devices.

The computer-readable program described herein can be downloaded to various computing/processing devices from the computer-readable storage medium or can be downloaded to external computers or external storage devices over a network, such as the Internet, a local area network (LAN), a wide area network (WAN), and/or a wireless network. Network adapter cards or network interfaces in each computing/processing device receive the computer-readable program instructions from the network and forward them for storage in the computer-readable storage medium within each computing/processing device.

In summary, the method for acquiring the target thickness of the hydrogen embrittlement-resistant layer of a neutron source target, the design method of the hydrogen embrittlement-resistant layer, the terminal, and the computer storage medium provided by the present disclosure perform, for a target comprising the hydrogen embrittlement-resistant layer, both a hydrogen diffusion performance evaluation and a comprehensive thermal performance evaluation. Based on the evaluation results, a target thickness that satisfies the preset condition of a hydrogen atom concentration field and the preset condition of a temperature field is obtained.

In this way, the target thickness of the hydrogen embrittlement-resistant layer-compatible with the physical field properties of other structural layers in the target (such as the functional layer)—can be determined quickly and conveniently, effectively improving the overall performance of the target while enhancing its resistance to hydrogen embrittlement. Furthermore, the method described herein can be applied to target structures employing different types of functional layer materials, thereby improving the scalability and flexibility of target structure design.

By performing hydrogen diffusion performance screening based on deposition distribution and coupling analysis and screening of thermal performance based on energy distribution for the targets corresponding to each candidate thickness of the hydrogen embrittlement-resistant layer, a target thickness that simultaneously satisfies the preset condition of a hydrogen atom concentration field and the preset condition of a temperature field is selected. This enables the rapid and convenient acquisition of a target thickness for the hydrogen embrittlement-resistant layer that is compatible with the thickness and material of the functional layer. This not only enhances the hydrogen embrittlement resistance of the target but also effectively improves the target's thermal performance. Additionally, by performing neutron yield screening for each candidate thickness of the hydrogen embrittlement-resistant layer and the corresponding target, the selected thickness is better adapted to the neutron yield characteristics of the target, thus further enhancing the comprehensive performance of the target. Moreover, the method described in the invention is applicable to target structures with different functional layer materials, thereby offering high scalability and flexibility.

The above-mentioned embodiments are merely illustrative of the principle and effects of the present disclosure instead of restricting the scope of the present disclosure. Any person skilled in the art may modify or change the above embodiments without violating the principle of the present disclosure. Therefore, all equivalent modifications or changes made by those who have common knowledge in the art without departing from the spirit and technical concept disclosed by the present disclosure shall be still covered by the claims of the present disclosure.

What is claimed is:

1. A method for acquiring a target thickness of a hydrogen embrittlement-resistant layer of a neutron source target, wherein the target comprises a functional layer, a hydrogen embrittlement-resistant layer, and a target substrate; the method comprises:
determining a current thickness of the hydrogen embrittlement-resistant layer, wherein the current thickness is greater than or equal to a reference thickness of the hydrogen embrittlement-resistant layer;
using a physical field fitting method, performing hydrogen diffusion performance fitting based on the deposition distribution and thermal performance fitting based on the energy distribution for the target, respectively, to correspondingly obtain hydrogen atom concentration distribution characteristic and temperature distribution characteristic corresponding to the current thickness;
determining whether the hydrogen atom concentration distribution characteristic satisfies a preset condition of a hydrogen atom concentration field, and determining whether the temperature distribution characteristic satisfies a preset condition of a temperature field. if both two conditions are satisfied, then taking the current thickness as the target thickness of the hydrogen embrittlement-resistant layer;
wherein the reference thickness is determined based on the material and thickness of the functional layer, in combination with the incident proton beam energy of the target and the current material of the hydrogen embrittlement-resistant layer, so as to determine a reference thickness of the hydrogen embrittlement-resistant layer corresponding to the current material.

2. The method according to claim 1, further comprising:
If either of the two conditions is not satisfied, updating the current thickness based on a preset adjustment threshold, and re-performing the method for acquiring the target thickness of the hydrogen embrittlement-resistant layer based on the updated thickness, until the target thickness is obtained.

3. The method according to claim 1, wherein performing hydrogen diffusion performance based on the deposition distribution of the target using the physical field fitting method comprises:
converting a proton flux into a corresponding hydrogen atom molar flow rate; based on the hydrogen atom molar flow rate, respectively obtaining the hydrogen atom concentration distribution along an incident direction and along a reference plane of the target using the physical field fitting method, and extracting a maximum hydrogen atom concentration from the hydrogen atom distribution of the target.

4. The method according to claim 3, wherein obtaining the hydrogen atom concentration distribution of the target along the incident direction using the physical field fitting method comprises:
calculating the hydrogen atom concentration distribution along the incident direction of the proton beam in the target using a Monte Carlo method;
and/or,
wherein obtaining the hydrogen atom concentration distribution along the reference plane using the physical field fitting method comprises:
calculating a hydrogen atom concentration distribution along the reference plane of the proton beam using a finite element simulation method, to obtain a three-dimensional hydrogen atom concentration distribution of the proton beam.

5. The method according to claim 4, wherein the three-dimensional hydrogen atom concentration distribution of the proton beam is:
$${f}_{sc} ( x , y , z ) = \frac{1}{2 {πσ}^{2}} exp ( - \frac{{x}^{2} + {y}^{2}}{2 {σ}^{2}} ) * {f}_{sc} ( z )$$
wherein f_{sc}(x, y, z) is the hydrogen atom concentration distribution of the proton beam in the three-dimensional space, x, y are coordinates of the proton beam along the reference plane; z is a coordinate of the proton beam along the incident direction;
and o is a standard deviation of a planar Gaussian distribution.

6. The method according to claim 1, wherein performing the thermal performance fitting based on the energy distribution using the physical field fitting method comprises:
converting a power of the proton beam into a corresponding heat source power of the target;
according to the heat source power, respectively obtaining a temperature distribution of the target along the incident direction and a temperature distribution of the target along the reference plane using the physical field fitting method, and extracting a maximum temperature from a temperature distribution corresponding to the target; and extracting a maximum temperature from a temperature distribution corresponding to the target.

7. The method according to claim 6, wherein obtaining the temperature distribution along the incident direction using the physical field fitting method comprises:
calculating a temperature distribution along the incident direction of a proton beam in the target using a Monte Carlo method; and/or,
wherein obtaining the temperature distribution along the reference plane using the physical field fitting method comprises:
calculating a temperature distribution of the proton beam along the reference plane using a finite element simulation method, to obtain a three-dimensional temperature distribution of the proton beam.

8. The method according to claim 7, wherein the three-dimensional temperature distribution of the proton beam is:
$${f}_{nl} ( x , y , z ) = \frac{1}{2 {πσ}^{2}} exp ( - \frac{{x}^{2} + {y}^{2}}{2 {σ}^{2}} ) * {f}_{nl} ( z )$$
wherein fₙₗ(x, y, z) is the temperature distribution of the proton beam in the three-dimensional space; fₙₗ(z) is the temperature distribution of the proton beam along the incident direction; x, y are coordinates of the proton beam along the reference plane; z is a coordinate of the proton beam along the incident direction; and o is a standard deviation of a planar Gaussian distribution.

9. The method according to claim 1, further comprises:
performing a neutron yield performance evaluation for a target comprising the hydrogen embrittlement-resistant layer with the target thickness, to obtain a target thickness that satisfies a preset condition of neutron yield performance evaluation.

10. A method for designing a hydrogen embrittlement-resistant layer of a neutron source target, wherein the target comprises a functional layer, a hydrogen embrittlement-resistant layer, and a target substrate; the method comprises:
determining a current material of the hydrogen embrittlement-resistant layer, wherein the current material is a material with a hydrogen diffusion coefficient greater than that corresponding to the target substrate;
determining a reference thickness corresponding to the current material according to a material and thickness of the functional layer, an energy of an incident proton beam of the target, and the current material of the hydrogen embrittlement-resistant layer;
acquiring a target thickness of the hydrogen embrittlement-resistant layer based on the reference thickness using any of the methods as claimed in claims 1 to 8;
based on the target thickness, detecting whether a neutron yield distribution of the target corresponding to the target thickness satisfies a preset neutron yield condition; if satisfied, determining the target thickness as the target thickness corresponding to the current material;
combining the current material and the corresponding target thickness to obtain a design scheme of the hydrogen embrittlement-resistant layer.

11. The method according to claim 10, wherein detecting whether the neutron yield distribution corresponding to the target thickness satisfies the preset neutron yield condition comprises:
constructing a simulation model for simulating a proton beam vertically bombarding the target based on the target corresponding to the target thickness, wherein the simulation model is a spherical coordinate system centered on the target;
extracting a neutron yield within a preset radiation range along a proton emission direction of the target in the simulation model;
detecting whether the neutron yield satisfies a preset yield threshold; if so, determining that the neutron yield of the target corresponding to the target thickness meets the preset neutron yield requirement.

12. A terminal, wherein the terminal comprises a processor and a memory; the memory is configured to store a computer program, and the processor is configured to execute the computer program stored in the memory, so that the terminal performs the method for acquiring the target thickness of the hydrogen embrittlement-resistant layer of the neutron source target according to claim 1, or the method for designing the hydrogen embrittlement-resistant layer according to claim 10.

13. A computer-readable storage medium storing a computer program, wherein the computer program, when executed by a processor, implements the method for acquiring the target thickness of the hydrogen embrittlement-resistant layer of the neutron source target according to claim 1, or the method for designing the hydrogen embrittlement-resistant layer according to claim 10.
